(19) United States
(12) Patent Application Publication
(10) Pub. No.: US 2008/0276012 A1
(43) Pub. Date: Nov. 6, 2008

(54) Driver Loading via a PnP Device

(76) Inventors: Joe Mesa, Irvine, CA (US); Charlie Raasch, Lake Forest, CA (US)

Correspondence Address: PATENTMETRIX, 14252 CULVER DR. BOX 914, IRVINE, CA, 92604, US

(21) Appl. No.: 12/114,747

(22) Filed: May 3, 2008

Related U.S. Application Data
(60) Provisional application No. 60/915,947, filed on May 4, 2007.

(51) Int. Cl. G06F 3/00

(52) U.S. Cl. 710/13

(57) ABSTRACT

The present invention enables a USB device to provide its own vendor-specific device driver and invoke and install vendor-specific installation software stored on the USB device itself. In one embodiment of the invention, the present invention enables communication between a USB device and a host by receiving a USB device into a USB connection port embedded within the host, enumerating the USB device as a device belonging to a first class, providing a user with access to the USB device wherein the access permits a user to find a program for the USB device and invoke the program, installing the stored program; and recognizing and/or enumerating the USB device as a device from a second class, different from the first class, upon any successive connection of the USB device into the USB connection port of the host.

### CROSS-REFERENCE

The present application relies on for priority U.S. Provisional Application No. 60/915,947, entitled “A Method for Driver Loading via a USB Device” filed May 4, 2007.

### FIELD OF THE INVENTION

The present invention relates generally to methods for using device driver data on a host computer for PnP devices, such as a keyboard, monitor or mouse and, more particularly, to invoking and installation of device driver software from the corresponding PnP device, such as USB devices, itself.

### BACKGROUND OF THE INVENTION

The Universal Serial Bus (USB) is a cable bus that supports data exchange between a host computer and a wide range of simultaneously accessible peripheral devices. The attached peripheral devices share USB bandwidth through a host-scheduled, token-based protocol. The bus allows peripherals to be attached, configured, used, and detached while the host and other peripherals are in operation. The USB is defined by a specification that is approved by a committee of industry representatives. The specification covers all aspects of USB operation, including electrical, mechanical, and communications characteristics. To be called a USB device, a peripheral must conform to this specification.

The USB architecture defines a layered software scheme which includes, at the highest level, client drivers; at an intermediate level, USB system software; and at the lowest level, host controller software. Transactions performed over the USB are controlled by the USB's device driver. The device (or hub client) may be class specific or vendor specific. Accordingly, each hub client requires a corresponding driver which is tailored to the specific device class or device vendor. A driver accesses its corresponding hub client by requesting an I/O transfer using an I/O request packet (IRP). System software allocates the necessary bandwidth for the transfer and directs the IRP to its destination hub client. The host controller software communicates with a USB host controller for the actual transmission of control and data information to and from the USB devices.

The process of discovering a newly inserted USB device is commonly referred to as device enumeration. To a host, a system power up, or a device insertion are essentially identical. A host must first turn on power to its USB ports. This enables the host to identify devices on the bus. Regardless of the device type, the USB device will pull up one of the data lines to the host, indicating to the host the presence of a device.

Once a device has been identified, the host will reset the port, which puts the device into an unaddressed state. Therefore, per the USB specification, the device will only acknowledge packets on the bus addressed to USB address 0. The host begins the process of retrieving the device's descriptors. These are known data structures specified by the USB, which the host uses in order to determine the device's class, the particular manufacturer of the device, product information, among other data. There are several main device descriptors used during the enumeration processes. These descriptors are defined in the USB standard and provide a mechanism for the USB host to identify certain characteristics about the device, including the device, configuration, interface, and endpoint descriptors.

The first communication between the USB host and the USB device is typically a standard USB request to retrieve the device's device descriptor. This 9 byte data structure has several key pieces of information which include the vendor ID, product ID, class and subclass codes. The vendor ID is assigned by the USB and the product ID is a 16 bit value which the manufacturer can use to uniquely identify a particular product.

The class and subclass values are used to define particular pre-defined class types which the USB has specified. As an example, a USB keyboard or mouse would be a certain class (HID), and the subclass would identify the device is a keyboard or the device is a mouse. The purpose of the pre defined classes is that like devices would generally behave the same. Therefore, rather than require the USB host operating system to provide manufacturer specific drivers for each USB keyboard or mouse, the USB host operating system could have a single driver which is capable of supporting all devices which conform to a particular class and/or subclass.

A device may also indicate its class and subclass type in the interface descriptor, to allow for composite devices, that is, a physical device which exhibits multiple interfaces. Although found in the interface descriptor, the behavior is exactly the same as if the host operating used the class and subclass values found in the device descriptor. Therefore, the host operating system, such as Windows, would use this information to determine which driver to load in support of the downstream USB device.

The benefit of using pre-defined class types is that if the host operating system contains support for a specific USB defined class type and the device conforms to the class specification, the host operating system will natively support the downstream USB device by way of a class, sub-class specific generic device driver. The disadvantage is that the device manufacturer is limited in how they can differentiate their product against other products in the same type.

Another disadvantage is that if the USB has not defined a standard for a particular behavior for a device then the device manufacturer must provide a manufacturer specific (often described as a vendor specific) driver. Typically, manufacturers deliver an optical media (CD or DVD) with an installation package, for the purposes of installing the appropriate driver support. Most users, however, often lose the installation CD or DVD. Manufacturers often enable users to download the device drivers over the Internet, but this requires a user to be connected, and if the user is using a slow internet connection, the download times can often be lengthy.

Accordingly, there is need in the art for a USB device to have the ability to provide its own vendor-specific device driver. There is also need in the art for a method to enable invoking and installation of vendor-specific installation software stored on the USB device itself.

### SUMMARY OF THE INVENTION

It is an object of the present invention to enable a USB device to provide its own vendor-specific device driver. It is another object of the present invention to provide a novel method to invoke and install vendor-specific installation software stored on the USB device itself.

According to an object of the present invention the USB device stores a vendor-specific driver installation package on the USB device itself.

According to one embodiment of the present invention the USB device, on plugging into a host PC, enumerates and initially operates as a Mass Storage Class Device with class 0×08, subclass 0×06. Thus, the descriptors read by the USB host from the USB device indicate a single Mass Storage Device (0×08), which supports the Bulk Only Transport (0×06) comprising of a two BULK endpoints IN and OUT. Mass Storage Devices, such as USB thumb drives, are well known in the art and most modern operating systems natively support this USB Mass Storage Class. Thus, the built-in Mass Storage Class Driver for the operating system is automatically invoked that initially displays the USB device as a removable storage media icon.

A user is then able to browse the storage media (on the USB device) and execute a vendor-specific driver installation software package stored thereon. Upon installation and invocation of the vendor-specific driver, the driver issues a command to the USB device to indicate that the device should switch and no longer operate as a Mass Storage Device, but rather operate as a proprietary USB device, such as an Audio/Video device in one embodiment. Thus, the USB device is capable of supporting both Mass Storage Commands and Vendor Specific commands through the same interface. The vendor specific commands are used to put the device into different modes, and control the behavior of the device.

In one embodiment of the invention, the present invention is directed to a method for enabling communication between a USB device and a host comprising the steps of receiving a USB device into a USB connection port embedded within said host, enumerating the USB device as a device belonging to a first class, providing a user with access to said USB device wherein said access permits a user to find a program for said USB device and invoke said program, installing said stored program; and recognizing and/or enumerating the USB device as a device from a second class, different from said first class, upon any successive connection of said USB device into the USB connection port of said host.

Optionally, the first class is a mass storage device and the second class is not a standard USB class. The USB device comprises descriptors indicative of a mass storage device, such as descriptors indicative of a mass storage device that supports bulk only transport and including two bulk endpoints. The installation of the program causes a driver to be installed on said host.

Optionally, upon any successive connection of said USB device into the USB connection port of the host, the host invokes the driver matching USB device data, such as vendor ID or product ID. Optionally, when the driver is invoked, the host issues commands to the USB device to cause the USB device to operate as a second class device instead of a second class device.

In another embodiment, the present invention is directed to a method for enabling communication between a USB device and a host, comprising the steps of receiving a USB device into a USB connection port embedded within the host wherein the USB device comprises descriptors indicative of a mass storage device, enumerating the USB device as a mass storage device, providing a user with access to the USB device wherein the access permits a user to find a program for said USB device and invoke said program, installing the stored program, wherein the installation causes a driver to be installed on said host, when the driver is invoked, issuing instructions to the USB device to cause the USB device to switch from operating as a mass storage device to a device of a different class, and recognizing and/or enumerating the USB device as a device from a different class upon any successive connection of said USB device into the USB connection port of said host. Optionally, the descriptors are indicative of a mass storage device that supports bulk only transport and comprises two bulk endpoints. Optionally, upon any successive connection of the USB device into the USB connection port of the host, the host invokes the driver matching USB device data, including vendor ID or product ID.

### BRIEF DESCRIPTION OF THE DRAWINGS

These and other features and advantages of the present invention will be appreciated, as they become better understood by reference to the following detailed description when considered in connection with the accompanying drawings, wherein:

FIG. 1 shows a block diagram of an exemplary USB system;

FIG. 2 shows a flow chart of conventional enumeration (device recognition) processing in a USB system;

FIG. 3 is a flow chart depicting exemplary steps related to the installation and invoking of vendor-specific device driver stored on the USB device; and

FIG. 4 depicts an exemplary icon that is displayed to a user when the USB device of the present invention is initially plugged in to the host.

### DETAILED DESCRIPTION OF THE INVENTION

While the present invention may be embodied in many different forms, for the purpose of promoting an understanding of the principles of the invention, reference will now be made to the embodiments illustrated in the drawings and specific language will be used to describe the same. It will nevertheless be understood that no limitation of the scope of the invention is thereby intended.

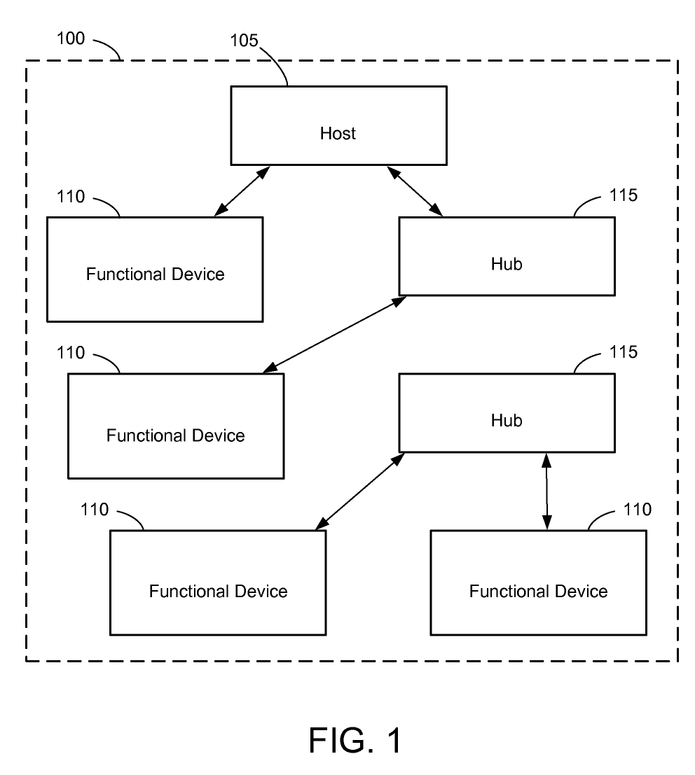

FIG. 1 shows a block diagram of an exemplary USB system 100 comprising a host 105 (hereinafter referred to as the ‘host’) positioned at a root of a typical tree-shaped USB topology (hereinafter referred to as the ‘device tree’). The host is a computer or a computing device having a processing unit and at least one USB connection port. Computing devices may include, but are not limited to cell phones, personal data assistants, mini computers, main frames, personal computers, distributed computing systems, networks, laptops, desktops or combinations thereof. The host 105 comprises USB circuitry, including a USB host controller, (not shown) as described in the “Universal Serial Bus Specification” (Rev. 2.0, Apr. 27, 2000), which is published by Compaq, HP, Intel, Lucent, Microsoft, NEC and Philips, and is incorporated herein by reference. The host also runs an operating system such as the Windows OS from Microsoft or any other operating system which supports the USB architecture as specified in the “Universal Serial Bus Specification”.

The host 105 recognizes a USB peripheral device 110 (hereinafter referred to as the ‘device’) existing at a terminal point of the device tree and transmits/receives data to/from the device 110 on a one-to-one basis. USB devices are classified into two categories, one is “hub device” that provides the USB with new connection points, and the other is “function device” that serves as the peripheral of the system, namely a mouse, a keyboard, a monitor or a printer, for instance.

FIG. 1 shows hubs 115 positioned at nodes of the device tree which perform functions such as relaying a packet transmission from the upstream (on the host side) to the downstream (on the device side), and from the downstream to the upstream, and detecting connection/disconnection to/from a device located at a downstream node/terminal point. Thus, a USB device 110 can be directly coupled to the host 105 or connected to the downstream of the hub 115. The hub 115 can also be directly coupled to the host 105 and connected to the downstream of the hub 115 in a manner similar to a general device 110. The relationship between the host 105 and the device 110 in the USB connection is asymmetric. In other words, all communications are started by the host 105, and the device 110 responds to a communication started by the host 105. Therefore, communication packets from the host 105 to the device 110 are sent across the entire tree device through the hub 115. A one-to-one virtual communication path between the host 105 and a device 110 on the USB is called a “pipe.”

The USB device also includes an endpoint structure, and in the USB device, each endpoint is an independent division that acts as the data output or reception terminal during the data transmission between the USB host and the device. Each USB device may possess a set of endpoints adapted for various data transmission characteristics. The endpoints are categorized into control, bulk, interrupt, and isochronous endpoints. Except for control endpoints, which allow bidirectional data transmission, the rest are further divided into input and output endpoints.

USB devices possess a set of maximum sixteen endpoints which are used to implement device functions, and each endpoint is assigned with a unique number called “endpoint number”. Therefore, the combination of device address, endpoint number and data transmission direction (output or input) enables the endpoint to acquire a unique and specific address on USB Bus.

Referring back to FIG. 1, the host 105 also comprises device driver software that communicate with the USB devices 110, 115 via USB function interface programs provided so as to execute the device function. That is, the device driver and the USB function program have a one-to-one relationship. Each USB device 110, 115 needs to have a corresponding function program within the host 105 for the purpose of executing the function provided by the device 110, 115 in the system 100. In order to provide the convenience of USB plug-and-play (PnP) function, several function device drivers that are commonly used are typically already embedded in the operating system. Hence, when the device 110, 115 is connected to USB Bus, the system 100 can find the embedded software and executes the function thereof without additional software installation, thus making the USB easier to use.

When the USB device 110, 115 (a hub or a function device) is connected to USB Bus, the USB host 105 executes an enumeration process wherein the host 105 assigns a single unique address to the device 110, 115 and then the USB host 105 communicates with the USB device 110, 115 according to the single unique address; in other words, each USB device 110, 115 has only one address.

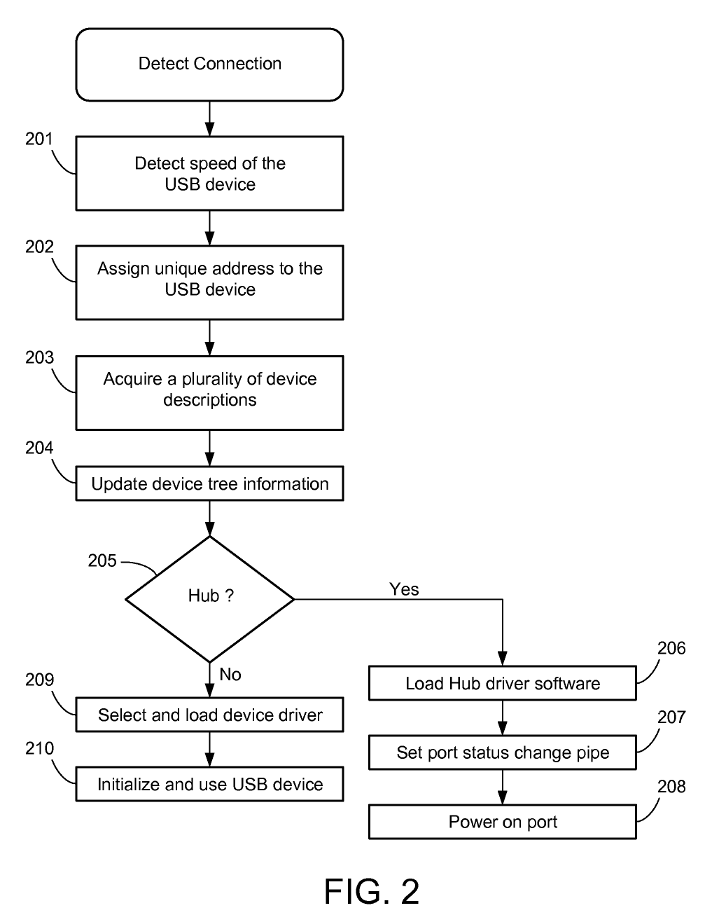

FIG. 2 shows a flow chart of conventional enumeration (device recognition) processing. The enumeration begins with detection of devices connected to hub ports (including the port of the host) which have been powered on. A device connection at a downstream hub is detected through the hub status change pipe. Upon receipt of a reset signal from the upstream, a device starts up with a default address (address 0) being regarded as destined to itself, and is assigned a unique device address by a control command sent from the host to operate subsequently.

Specifically, the host detects a device speed at step 201, and assigns an address to the device at step 202. The host typically records information related to each of devices in a tree shape corresponding to the bus topology in preparation for post-processing. Recorded information includes information for calling driver software for software-based post-processing, in addition to a descriptor for acquiring a device.

USB device information is typically stored in descriptors or request codes that are data structures formatted as specified by the USB specification. Descriptors are used in a USB system to define device requests from a host to a peripheral device. A device request is a data structure that is conveyed in a control transfer from the host to the peripheral device. A control transfer contains the following fields in accordance with the USB protocol:

bmRequestType—a mask field indicating (a) the direction of data transfer in a subsequent phase of the control transfer; (b) a request type (standard, class, vendor, or reserved); and (c) a recipient (device, interface, endpoint, or other). The primary types of requests specified in the “request type” field are the “standard” and “vendor” types.
bRequest—a request code indicating one of a plurality of different commands to which the device is responsive.
wValue—a field that varies according to the request specified by bRequest.
wIndex—a field that varies according to request; typically used to pass an index or offset as part of the specified request.
wLength—number of bytes to transfer if there is a subsequent data stage.

All USB devices are supposed to support and respond to standard requests - referred to herein as USB-specific requests. In USB-specific requests, the request type portion of the bmRequestType field contains a predefined value indicative of the standard request type.

Each different USB-specific request has a pre-assigned USB-specific request code, defined in the USB specification. This is the value used in the bRequest field of the device request, to differentiate between different USB-specific requests. For each USB-specific request code, the USB specification sets forth the meanings of wValue and wIndex, as well as the format of any returned data.

Thus, in a typical USB communication, the host typically performs an action of sending a GET_DESCRIPTOR device request to the peripheral device. The GET_DESCRIPTOR device request is a standard, USB-specific request, identified in a control transfer by the GET_DESCRIPTOR request code (bRequest=GET_DESCRIPTOR).

Persons of ordinary skill in the art would appreciate that Chapter 9 of the “Universal Serial Bus Specification” (Rev. 2.0, Apr. 27, 2000) defines standard, device class, or vendor-specific requests that can be used to manipulate a device's state. Descriptors are also defined that can be used to contain different information on the device. Control transfers provide the transport mechanism to access device descriptors and make requests of a device to manipulate its behavior.

Referring back to FIG. 2, as the host acquires a variety of descriptors at step 203, the host updates device tree information at step 204. Then, the host determines whether a hub or a device is connected at step 205. When a hub is connected, the host loads a hub driver at step 206, sets a port status change pipe at step 207, and powers on the associated hub port at step 208. On the other hand, when the host determines that a device is connected, the host selects and loads a device driver at step 209, and initializes the device for using the device at step 210.

As mentioned earlier, the benefit of using pre-defined class types is that if the host operating system comprises support for a specific USB defined class type and the device conforms to the class specification, the host operating system will natively support the downstream USB device leading to rapid plug-and-play functionality. However, this limits the functionality that a generic class specific device driver can enable. In other words since the device driver in this case generically conforms to the device class, the functionality that the driver enables is also generic. For example, if a generic mouse driver is used, it will offer broad mouse functionalities and if a manufacturer has provided a mouse with enhanced operational features (to differentiate his product from competition) these may not be supported by the generic mouse driver natively supported by the host operating system.

In order to enable a user to use and operate enhanced features on the USB device, the manufacturer must provide custom/device-specific and vendor-specific driver software. Such vendor-specific device driver is typically provided on a CD and/or is downloaded from the vendor's website via Internet, for installation on the host PC.

The present invention is a USB device (hereinafter referred to as the ‘USB device invention’) that overcomes the aforementioned limitations of using generic device driver software or having to install a vendor-specific driver from another source such as a CD and/or Internet download.

In one embodiment of the present invention vendor-specific device driver installation package software is provided on the USB device invention itself. However, this poses a challenge for the USB host PC to retrieve the installation package from the USB device invention since the device's driver has not been initially installed. The present invention overcomes this challenge by allowing the USB host invention to initially enumerate and function as a USB-defined Mass Storage Class device. Such Mass Storage devices are defined, in the USB specification, with class 0×08, subclass 0×06 as known to persons of ordinary skill in the art. Most modern operating systems support such USB-defined Mass Storage devices due to the popularity of USB thumb drives. It should be appreciated that the USB device can be initially enumerated to function as a different USB standard class.

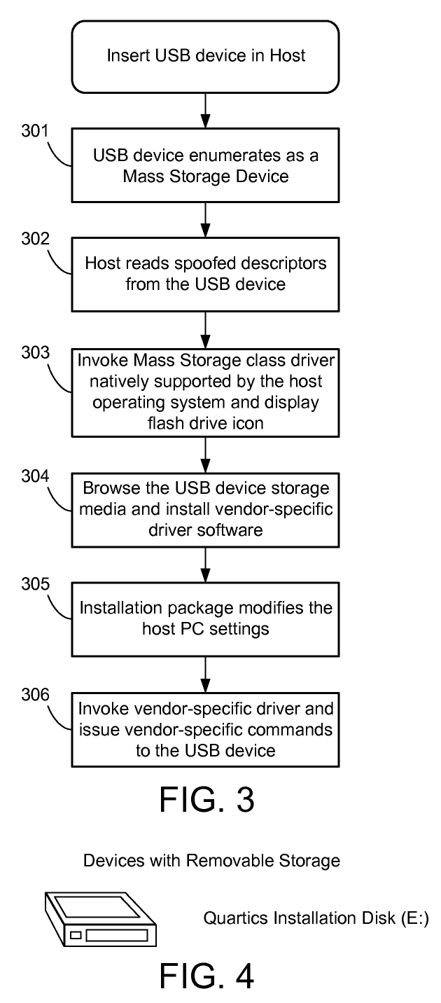

FIG. 3 depicts in a flow chart format the exemplary steps related to the installation and invoking of vendor-specific device driver stored on the USB device invention. When the USB device invention is inserted into a fresh PC host, it enumerates as a Mass Storage Device in step 301, similar to a USB Flash Disk. In step 302 the USB host PC reads spoofed ‘descriptors’ from the USB device invention. These spoofed ‘descriptors’ indicate a single Mass Storage Device (class—0×08), which supports Bulk Only Transport (subclass—0×06) comprising of a two BULK endpoints IN and OUT. As a result, the built-in (or natively supported) Mass Storage Class Driver for the operating system is invoked in step 303 and a removable storage icon, as shown in FIG. 4, appears.

The user, in step 304, double clicks on the icon to browse the storage media on the USB device invention and execute an installation software package thereby causing installation of a vendor-specific device driver for enabling enhanced features and functionalities of the USB device invention. In many operating systems, upon the appearance of a natively supported storage device, the operating system will automatically scan the storage device for drivers and automatically run the installation process, not requiring user intervention by a double click on the icon, and further simplifying the user install experience. In step 305, the installation software package modifies the USB host PC settings such that the existing USB Mass Storage software driver will no longer be run when the device is inserted, but rather, the newly installed vendor-specific driver is invoked matching on the device's vendor ID and product ID.

When the vendor-specific driver is invoked, in step 306, it issues vendor-specific commands to the downstream USB device invention to indicate the device to switch behavior and no longer operate as a Mass Storage Device, but rather operate as a proprietary USB device, of any type. As would be known to persons of ordinary skill in the art, USB devices optionally support vendor-specific requests. In a vendor-specific request, the request type portion of the bmRequestType field contains a predefined value to indicate a vendor request type. In the case of vendor-specific requests, the USB specification does not assign request codes, define the meanings of wValue and wIndex, or define the format of returned data. Rather, each device has nearly complete control over the meaning, functionality, and data format of vendor-specific requests. Specifically, the vendor can define his own requests and assign vendor-specified request codes to them. This allows for a device to have near plug-and-play functionality even if not supported by any of the generic drivers natively found in most operating systems.

The USB device invention is capable of supporting both Mass Storage Commands and Vendor-Specific commands through the same interface. The vendor specific commands are used to put the device into different modes, and control the behavior of the device.

It should be evident to persons of ordinary skill in the art that although the USB device invention always enumerates as a Mass Storage Class device, any PC which has had the vendor-specific installation package installed, will not invoke the USB host PC's storage driver, but rather, would invoke the installed vendor-specific driver. It should also be evident to persons of ordinary skill in the art that any USB device can be enabled by the systems and methods of the present invention.

The present invention is applicable to the installation of device driver software for any PnP operating environment which has natively installed drivers and vendor specific drivers. This applies to PCIe, SATA and other PnP environments. More specifically, the present invention is directed to a method for enabling communication between a computing system having a PnP operating environment and a peripheral, comprising the steps of providing within the peripheral programmatic code having at least two classes of functions, wherein a first of said two classes is used to store information regarding the execution of a second of the two classes and wherein the information contains execution directions for operating the second class of function on the peripheral, and connecting the peripheral to the computing system, wherein, upon connection, the computing system enumerates the first class on the peripheral and enables a transfer of stored information from the peripheral to the computing system and wherein the computing system acts on the information provided through the first class of function on the peripheral to enable operation of the second class of function.

The above examples are merely illustrative of the many applications of the methods of the present invention. Although only a few embodiments of the present invention have been described herein, it should be understood that the present invention might be embodied in many other specific forms without departing from the spirit or scope of the invention.

We claim:

1. A method for enabling communication between a USB device and a host, comprising the steps of:
a. Receiving a USB device into a USB connection port embedded within said host;
b. Enumerating the USB device as a device belonging to a first class;
c. Providing a user with access to said USB device wherein said access permits a user to find a program for said USB device and invoke said program;
d. Installing said stored program; and
e. Recognizing the USB device as a device from a second class, different from said first class, upon a successive connection of said USB device into the USB connection port of said host.

2. The method of claim 1 wherein said first class is a mass storage device.

3. The method of claim 1 wherein said second class is not a standard USB class.

4. The method of claim 1 wherein the USB device comprises descriptors indicative of a mass storage device.

5. The method of claim 4 wherein said descriptors are indicative of a mass storage device that supports bulk only transport and comprises two bulk endpoints.

6. The method of claim 1 wherein the installation of said program causes a driver to be installed on said host.

7. The method of claim 6 wherein, upon any successive connection of said USB device into the USB connection port of said host, the host invokes the driver matching USB device data.

8. The method of claim 7 wherein said USB device data comprises a vendor ID.

9. The method of claim 7 wherein said USB device data comprises a product ID.

10. The method of claim 6 wherein, when the driver is invoked, said host issues commands to the USB device to cause the USB device to operate as a second class device instead of a second class device.

11. The method of claim 10 wherein said first class is a mass storage device.

12. A method for enabling communication between a USB device and a host, comprising the steps of:
a. Receiving a USB device into a USB connection port embedded within said host wherein the USB device comprises descriptors indicative of a mass storage device;
b. Enumerating the USB device as a mass storage device;
c. Providing a user with access to said USB device wherein said access permits a user to find a program for said USB device and invoke said program;
d. Installing said stored program, wherein said installation causes a driver to be installed on said host;
e. When the driver is invoked, issuing instructions to the USB device to cause the USB device to switch from operating as a mass storage device to a device of a different class; and
f. Recognizing the USB device as a device from a different class upon any successive connection of said USB device into the USB connection port of said host.

13. The method of claim 12 wherein said descriptors are indicative of a mass storage device that supports bulk only transport and comprises two bulk endpoints.

14. The method of claim 12 wherein, upon any successive connection of said USB device into the USB connection port of said host, the host invokes the driver matching USB device data.

15. The method of claim 12 wherein said USB device data comprises a vendor ID.

16. The method of claim 12 wherein said USB device data comprises a product ID.

17. A method for enabling communication between a computing system having a PnP operating environment and a peripheral, comprising the steps of:
a. providing within said peripheral programmatic code having at least two classes of functions, wherein a first of said two classes is used to store information regarding the execution of a second of said two classes and wherein said information contains execution directions for operating the second class of function on the peripheral; and
b. connecting said peripheral to the computing system, wherein, upon connection, said computing system enumerates the first class on the peripheral and enables a transfer of stored information from the peripheral to the computing system and wherein said computing system acts on the information provided through the first class of function on the peripheral to enable operation of the second class of function.

18. The method in claim 17 wherein subsequent connections between the computing system and the peripheral automatically switch to the second class of function.

19. The method of claim 17 wherein the PnP operating environment is one of PCIe or SATA.

20. The method of claim 17 wherein said first class is indicative of a mass storage device.
